(19) United States
(12) Patent Application Publication
(10) Pub. No.: US 2012/0274767 A1
(43) Pub. Date: Nov. 1, 2012

(54) CEILING FAN ACCESSORY UNIT

(75) Inventor: Charles Hornback, Sarasota, FL (US)

(73) Assignee: CB LLC, Sarasota, FL (US)

(21) Appl. No.: 13/544,162

(22) Filed: Jul. 9, 2012

Related U.S. Application Data
(63) Continuation-in-part of application No. 12/012,254, filed on Jan. 31, 2008, now Pat. No. 8,218,805.
Application No. 12/012,254 is a continuation-in-part of application No. 10/928,695, filed on Aug. 26, 2004, now abandoned.
(60) Provisional application No. 60/510,745, filed on Oct. 11, 2003.

(51) Int. Cl. H04B 7/00; H04N 7/18

(52) U.S. Cl. 348/143; 381/77; 348/E07.085

(57) ABSTRACT

A ceiling fan accessory unit of the present invention is constructed in a manner in which the accessories can be attached and supplied with electric power by mounting the ceiling fan accessory unit to an existing ceiling fan. The ceiling fan includes a fan unit that houses a fan motor that rotates a plurality of fan blades. The fan unit includes a bottom portion having electric power wires and a connection portion adapted to receive a connector. The ceiling fan accessory unit communicates with a wireless transmitter that transmits audio signals. The ceiling fan accessory unit includes a housing, a wireless receiver and at least one speaker.

### CROSS-REFERENCE TO RELATED APPLICATIONS

This application is a Continuation-In-Part of co-pending U.S. patent application Ser. No. 12/012,254 filed Jan. 31, 2008, which was published as U.S. Patent Application Publication No. 2008/0181426 on Jul. 31, 2008, which is a Continuation-In-Part of co-pending U.S. patent application Ser. No. 10/928,695, filed on Aug. 26, 2004, which was published as U.S. Patent Application Publication No. US2005/0078837 on Apr. 14, 2005, which claims the benefit of U.S. Provisional Application No. 60/510,745, filed Oct. 11, 2003.

### FIELD OF THE INVENTION

This invention relates to an accessory unit for a ceiling fan. The invention facilitates the ability to include various accessory to an existing ceiling fan without the need to include additional wiring.

### BACKGROUND OF THE INVENTION

Generally, audio speaker systems are maintained within their own physical housing, although, in recent years the popularity of placing speakers within other household structures and electronics has risen. The purpose of such a combination is to combine the functions of cooling and audio systems in one decorative, space saving location. Wireless transmission, particularly at or around 900 MHz, has enabled audio wireless systems to be used in conjunction with many household fixtures.

Problems in the prior art include the need to have separate mountings for speakers and ceiling fans, to have additional wiring for speakers and ceiling fans, to have separate types of speakers for varying types of signal inputs, to have conspicuous visible speakers, to have the desired location for speakers on a ceiling already occupied by a ceiling fan, among others, all of which aim to be addressed by the present invention. Additional problems in the prior art, particularly in the combination of speakers with other items, include poor sound quality, poor sound distribution, overheating, difficulty in installation, incompatibility between the speaker and the item, and other problems known by those of ordinary skill in the art.

In addition, it is required to provide additional wiring to include security devices in a home, commercial, or industrial spaces. However, it is often time consuming and expensive to provide for additional wiring for such items.

### SUMMARY OF THE INVENTION

A ceiling fan accessory unit of the present invention is constructed in a manner in which the accessories can be attached and supplied with electric power by mounting the ceiling fan accessory unit to an existing ceiling fan. The ceiling fan includes a fan unit that houses a fan motor that rotates a plurality of fan blades. The fan unit includes a bottom portion having electric power wires and a connection portion adapted to receive a connector. The ceiling fan accessory unit communicates with a wireless transmitter that transmits audio signals. The ceiling fan accessory unit includes a housing, a wireless receiver and at least one speaker.

The housing is adapted to be mounted to the connection portion of the bottom portion of the fan unit to hangingly support the housing from the fan unit of the ceiling fan. The wireless receiver is mounted to the housing, and the wireless receiver is adapted for connection to the electrical power wires of the fan unit. The wireless receiver communicates with the wireless transmitter to receive the audio signals. The at least one speaker is mounted to the housing, and the at least one speaker is adapted for connection to the electrical power wires of the fan unit. The at least one speaker is in communication with the wireless receiver to output the audio signals transmitted from the wireless transmitter.

An alternative embodiment provides a ceiling fan that includes a fan unit that houses a fan motor that rotates a plurality of fan blades. The fan unit includes a bottom portion having electric power wires and a connection portion adapted to receive a connector. The ceiling fan accessory unit communicates with a wireless transmitter that transmits audio signals. The ceiling fan accessory unit includes a housing, at least one speaker, and a security device.

The housing is adapted to be mounted to the connection portion on the bottom portion of the fan unit to hangingly support the housing from the fan unit of the ceiling fan. The at least one speaker is mounted to the housing, and the at least one speaker is adapted for connection to the electric power wires. The security device is mounted to the housing and the security device is adapted for connection to the electric power wires and the at least one speaker. The security device detects for the occurrence of a predetermined condition and upon the security device detecting the occurrence of the predetermined condition outputs a signal to control the at least one speaker to issue an audible output.

### BRIEF DESCRIPTION OF THE DRAWINGS

FIG. 1 is a generalized view of a wireless speaker system components and how they are connected.

FIG. 2 is a frontal view of a first embodiment of the ceiling fan housing member and all of its components.

FIG. 3 is an elevation view of a first embodiment of the ceiling fan housing member.

FIG. 4A is the first of a plan view series of a first embodiment of the ceiling fan housing member.

FIG. 4B is the second of a plan view series of a first embodiment of the ceiling fan housing member.

FIG. 4C is the third of a plan view series of a first embodiment of the ceiling fan housing member.

FIG. 5A is a frontal view of one embodiment of the transmitter.

FIG. 5B is a side view of one embodiment of the transmitter.

FIG. 5C is a top view of one embodiment of the transmitter.

FIG. 6A is a view of the base of one embodiment of the remote control.

FIG. 6B is a view of the cover of one embodiment of the remote control

FIG. 6C is a view of the keypad of one embodiment of the remote control

FIG. 7 is a below perspective view of a second fully assembled and mounted embodiment of the invention.

FIG. 8 is a side view of a second embodiment of the invention.

FIG. 9 is an exploded view of a second embodiment of the invention.

FIG. 10 is a top view of a second embodiment of the invention.

FIG. 11 is a cross section view, along line A-A, of a second embodiment of the invention.

FIG. 12 is an isometric view of a second embodiment of the invention.

FIG. 13 is a partial schematic view of an alternative embodiment of the ceiling fan accessory unit.

FIG. 14 is a partial schematic view of a modified alternative embodiment of ceiling fan accessory unit

FIG. 15 is a bottom view of the modified alternative embodiment of the ceiling fan accessory unit.

### DETAILED DESCRIPTION OF THE PREFERRED EMBODIMENTS

As shown in the accompanying figures, the present invention relates to a wireless speaker system 1 used in combination with a ceiling fan.

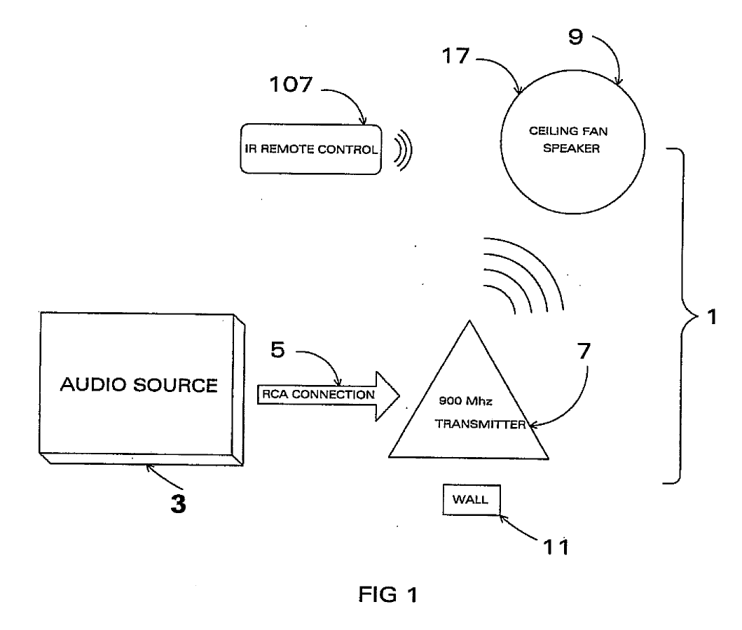

Referring to FIG. 1, the wireless speaker system 1 includes an audio source generator 3, RCA (The Radio Corporation of America) connectors 5, an audio input cord 99 (not shown in FIG. 1), a transmitter 7 mounted to a wall 11, speakers 17, a wireless receiver 9 and a remote control 107. It should be noted that “RCA” is a registered trademark of General Electric Company.

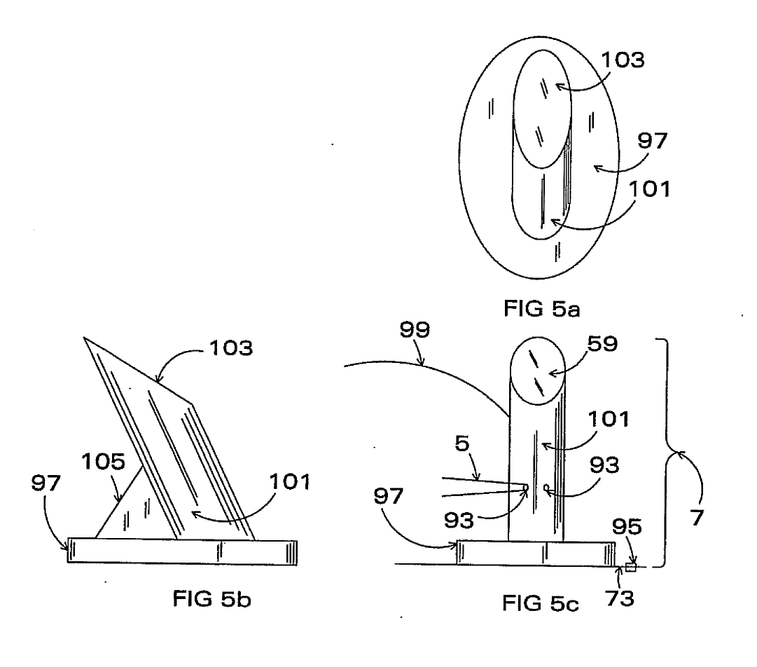

Referring collectively to FIGS. 5A, 5B, and 5C, an embodiment of a transmitter 7 of the present invention is shown in detail. The transmitter 7 has a base 97, a stand 101 with a support block 105 and a top surface 103. The transmitter 7 has two inputs 93 for audio source generators 3 and a wall transformer power source 95. As shown in FIG. 1, RCA connectors 5 connect the audio source generator 3 and the transmitter 7. An audio input cord 99 also runs to the transmitter 7. In one embodiment, the transmitter 7 is located within the wall 111.

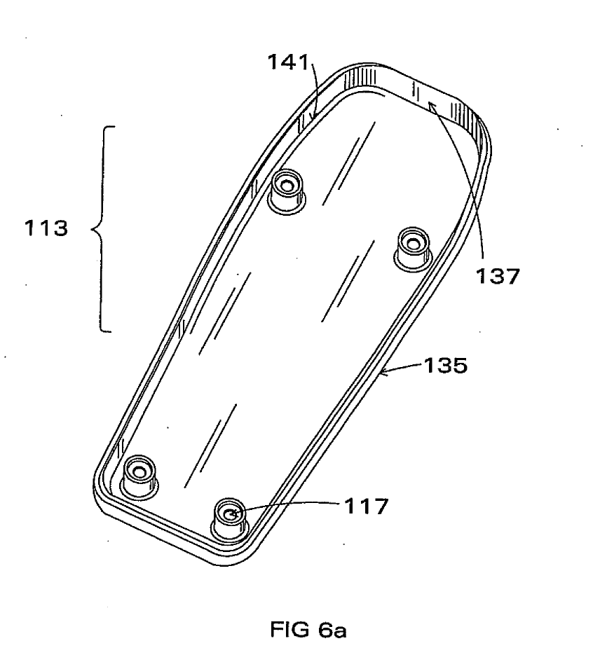

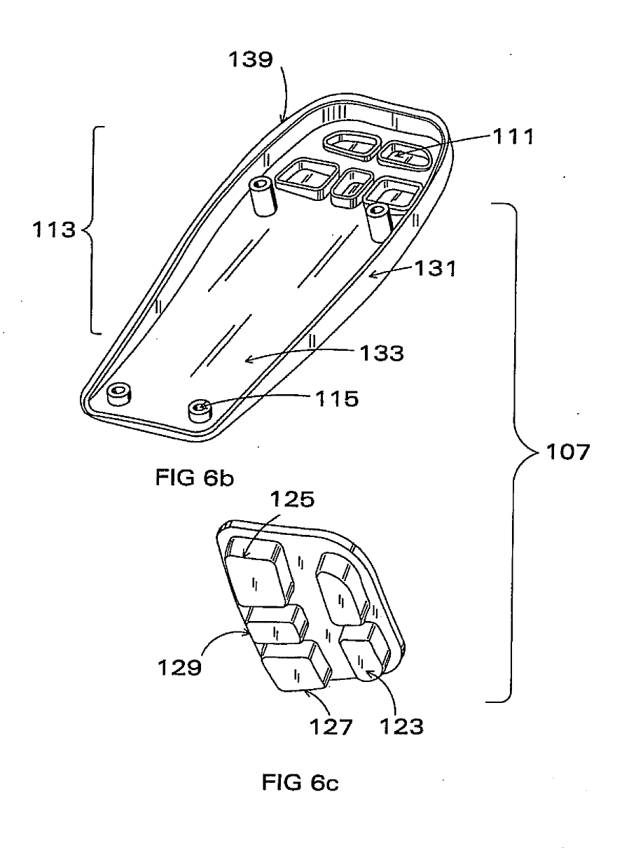

Referring collectively to FIGS. 6A, 6B, and 6C, an embodiment of a remote control 107 of the present invention is shown in detail. Preferably, the wireless speaker system 1 can be operated via a remote control 107. The remote control 107 comprises a remote control top 109 with keypad openings 111 and a remote control bottom 113. The remote control top 111 and the remote control bottom 113 are connected with fasteners 115 via the fastener apertures 117, the fasteners 115 being any suitable for connecting the remote control top 109 and the remote control bottom 113 known to those of ordinary skill in the art. The remote control top 109 has an outer surface 131 and an inner surface 133. The remote control bottom 113 also has an outer surface 135 and an inner surface 137. When the remote control top 109 and the remote control bottom 113 are attached via the fasteners 115, the top surface of the remote control top 139 and the top surface of the remote control bottom 141 meet so that there is no opening between the two. A keypad 119 may be present between the remote control top 109 and the remote control bottom 111. In a preferred embodiment, the remote control key pad 119 has five speaker control buttons: the speaker system on/off button 121, the light source on/off button 123, volume up 125, volume down 127 and the receiver channel 129. In an embodiment, the remote control 107 may able to turn the speaker system 1 on or off, the lights on or off, the volume of sound being produced from the speakers 17 up or down, change to channel of the receiver 9 to overcome any interference, or any combination thereof. In a preferred embodiment the remote control 107 operates via infrared transmission.

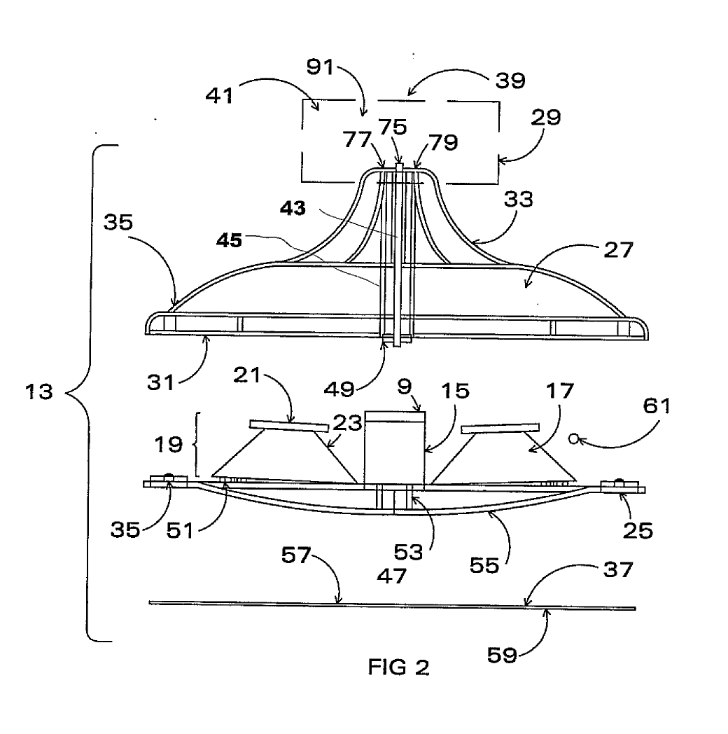

A first embodiment of an element of the present invention is detailed in FIGS. 2, 3, 4A, 4B and 4C, wherein the speaker 17 or speakers 17 of the present invention are directed downward from the ceiling, and away from the existing fan assembly 29. The existing fan assembly 29 includes a ceiling fan having a fan unit that houses a fan motor that rotates a plurality of fan blades. The fan unit having a bottom portion having accessory electrical power wires and a connection portion adapted to receive a connector, as described in greater detail below.

Referring to FIG. 2, the wireless receiver (also referred to as “RF Receiver”) 9 is located within the housing or ceiling fan housing member 13. The audio source generator 3 and the transmitter 7 are located distal from the wireless receiver 9. The amplifier 15 and the speakers 17, are also located in the ceiling fan housing member 13. The speakers 17 are enclosed by a speaker housing member 19 that consists of an upper surface 21 and a lateral surface 23.

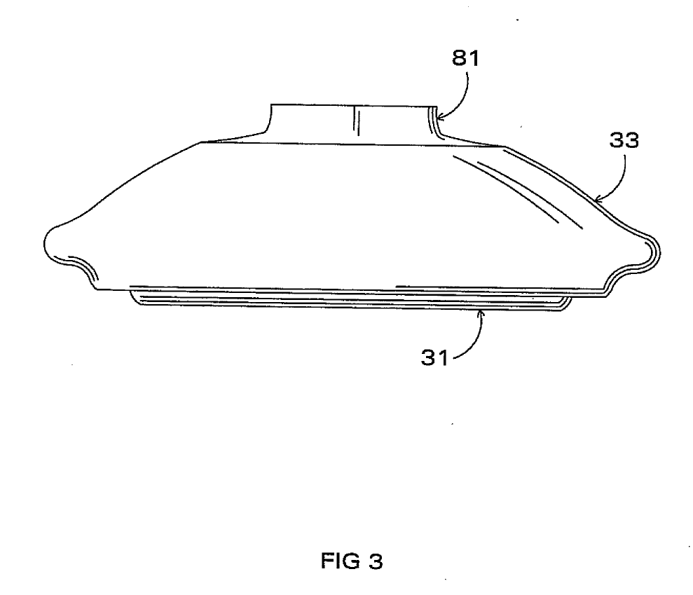

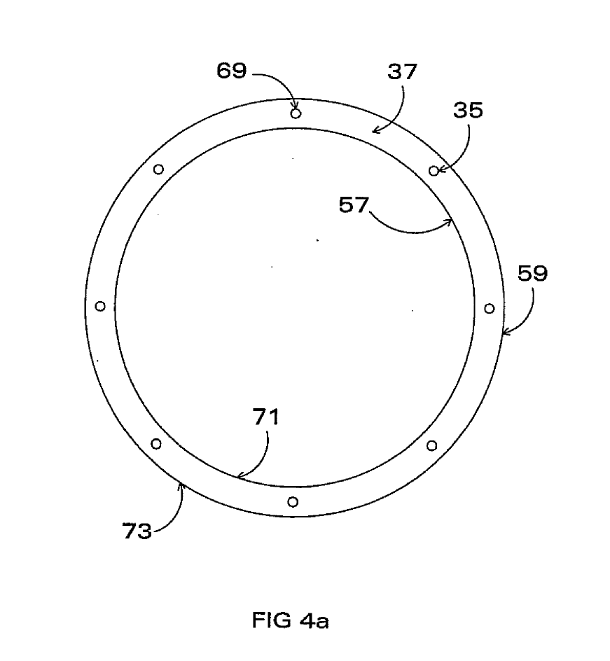

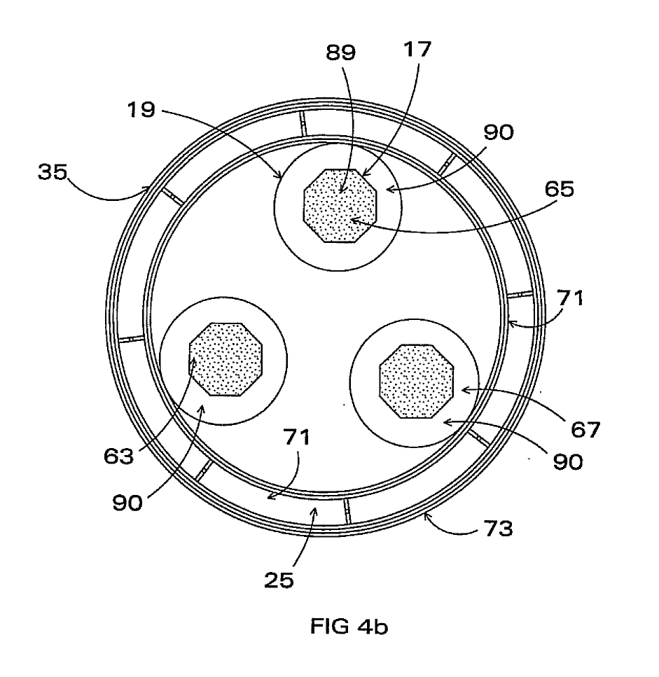

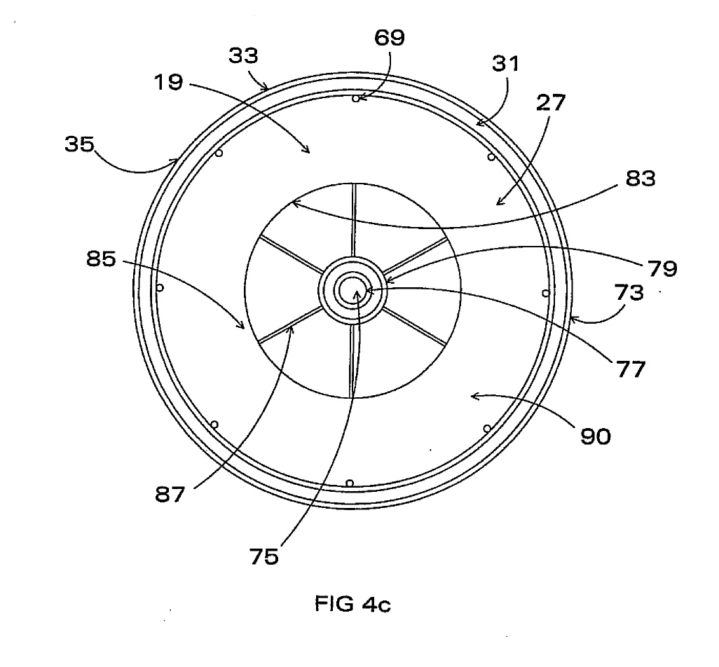

Referring to FIGS. 3, 4A, 4B and 4C, the speakers 17, in this first embodiment, consist of a bass speaker 63, a mid-range speaker 65 and a tweeter 67. Each speaker 17 has a sound grid 89 located on the outer surface 90 of the respective speakers 17. The speakers 17 may be virtually any suitable shape and size, the range of which is readily apparent to those of ordinary skill in the art, and may be dependent on the size of the ceiling fan housing member 13, the speaker housing member 19, or both. In a preferred embodiment, the speakers 17 are substantially circular and are about nine inches in diameter. In one embodiment, the speakers 17 range from between 2-32 ohms. In a preferred embodiment, the speakers 17 may range from 2-16 ohms.

Referring again to FIG. 2, the upper portion of the ceiling fan housing member 13, the globe 27, attaches directly to the existing fan assembly 29 through an aperture 75 in the globe 27. Two supporting rings, an inner ring 77 and an outer ring 79 reinforce the aperture 75. The globe 27 includes a bottom rim 31 and an outer surface 33. The connection 39 of the fan housing member 13 to the existing fan assembly 29 is shown in dotted lines on FIG. 2. The existing fan assembly 29 also contains a fan assembly motor 41.

Referring to FIG. 4C, the bottom rim 31 of the globe 27 has an interior rim 71 and an exterior rim 73. The globe 27 also has an upper ring 81 that connects to the existing fan assembly 29. The upper ring 81 has an interior surface 83 and an outer surface 85. Spokes 87 are attached to the interior surface 83 of the upper ring 81 to provide support to the globe 27. Also, housed within the globe 27 is the drive shaft 43. A drive shaft chamber 45 surrounds the drive shaft 43. Along the bottom rim 31 of the globe are fasteners 35 that connect the globe 27 to the lighting source 25 and the lens 37. The fasteners 35 connect the components by fastener openings 69.

Referring back to FIG. 2, the lower portion of the ceiling fan housing member 13, the lens 37, contains the speakers 17, wireless receiver 9 and amplifier 15 within an enclosed space 47. The lens 37 is connected to the globe 27 via a retaining nut 49. The speakers 17 are connected to the lighting source 25 via screws 51 and the receiver 9 and amplifier 15 are connected to the lighting source 25 via connectors 53. The light source 25 includes an illuminating bulb 55. The lens 37 has an inner surface 57 and an outer surface 59. The fan housing member 13 also contains a remote control input 61 (not shown).

A second embodiment of the present invention is detailed in FIGS. 7, 8, 9, 1 0, 11 and 12, wherein the speaker 17 or speakers 17 of the present invention are directed upwards toward the ceiling, and in the direction of the existing fan assembly 29. Besides this change in orientation of the speaker or speakers relative to the existing ceiling fan assembly 29, this second embodiment also includes additional components, and has an absence of some components of the first embodiment, as more fully illustrated in the Figures and described below. One particularly beneficial aspect to this second embodiment is the reduction of heat from the existing ceiling fan assembly 29 being introduced into the speaker 17, which improves performance, and is a distinguishing feature over the prior art.

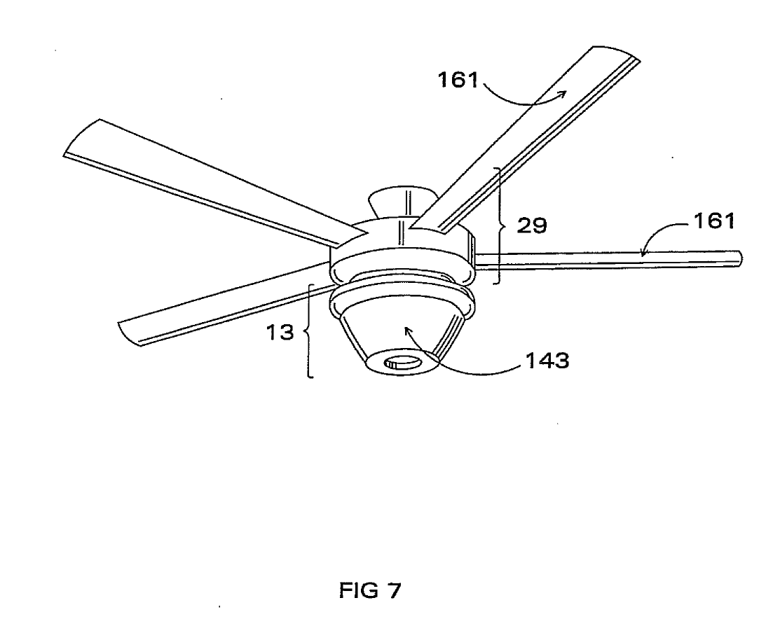

Referring to FIG. 7, a view from below of a fully assembled ceiling fan with the present invention installed thereon is visible. One particular design of this second embodiment is visible thereon, that being the speaker enclosure dome 143. The speaker enclosure dome houses the rear components of the speaker, and may optionally do so in an aesthetically pleasing manner. The receiver 9, amplifier 15, and remote control input 61 are among the components housed therein. The speaker enclosure dome 143 may be any suitable shape, but is preferably hemispherical or conical-frustral.

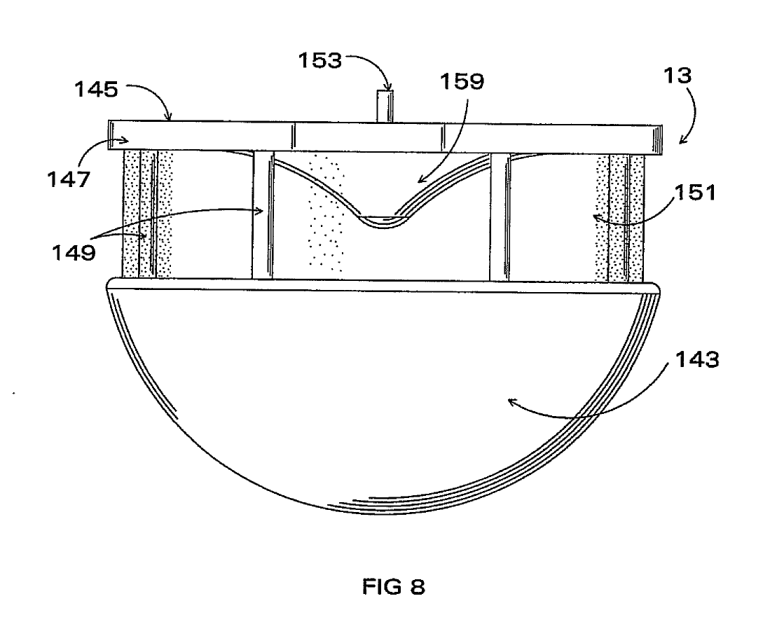

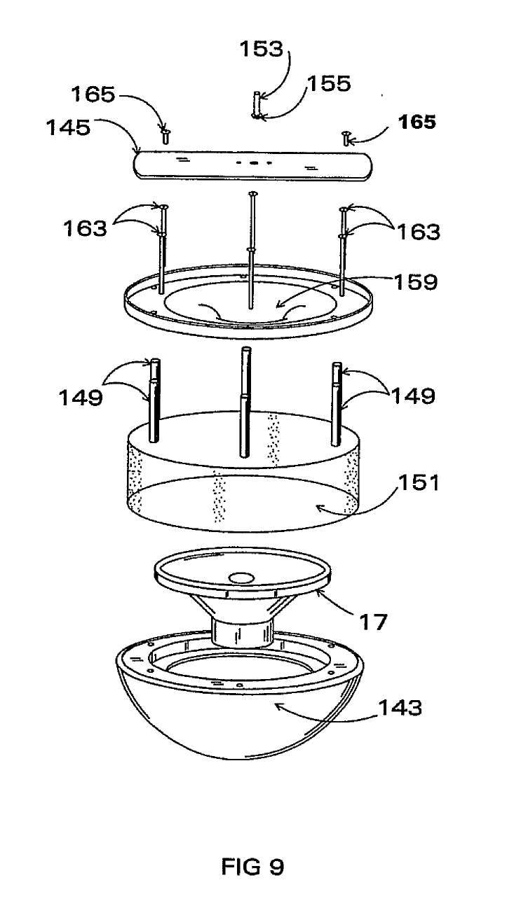

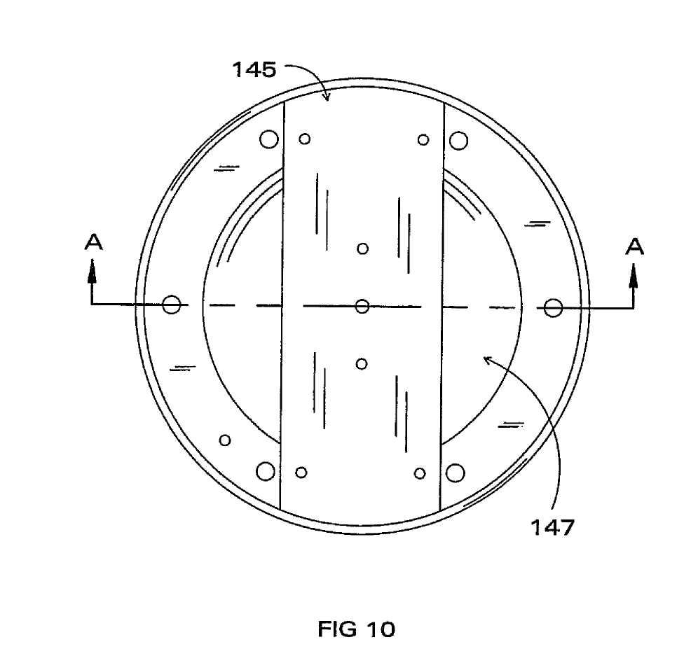

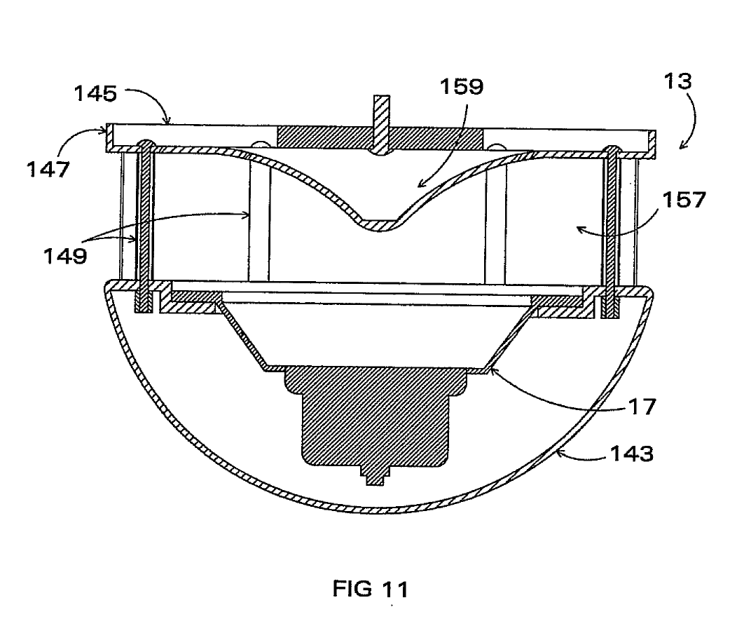

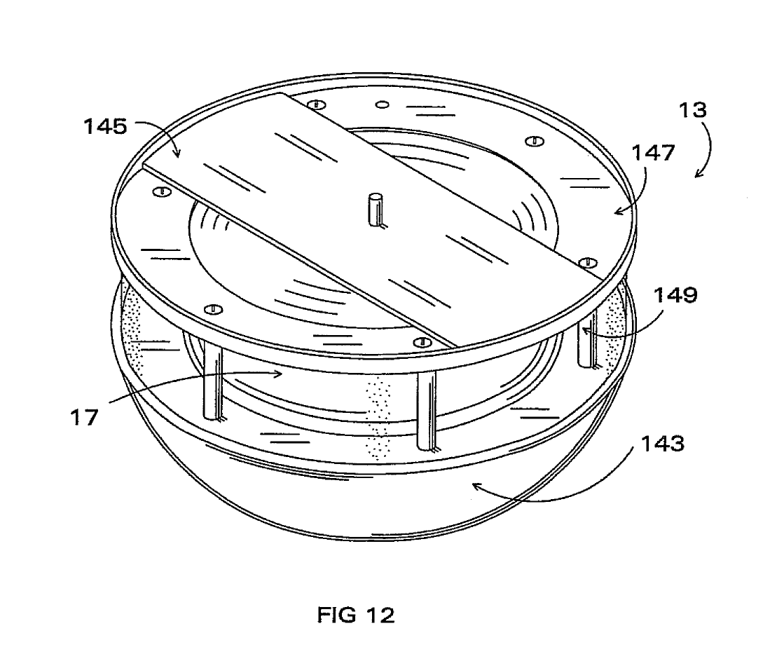

Referring to FIGS. 8, 9, 10, 11, and 12 collectively, several views of the ceiling fan housing member 13 of this second embodiment are visible. The globe 27 and the hardware associated therewith is not present in this second embodiment, and has been replaced by additional components, including a mounting bracket 145, an optional plate cover 147, one or more posts 149, and an optional screen 151. As can be seen in these Figures, which illustrate an embodiment where only one speaker 17 is present, the speaker dome enclosure 143 is supported by the one or more posts 149, which hold the speaker dome enclosure onto the mounting bracket 145. It is preferred that a series of posts 149 are present to provide support to the speaker dome enclosure 143.

The mounting bracket 145 in turn supports the entire ceiling fan housing member 13 onto the existing ceiling fan assembly 29. The mounting bracket 145 may be fastened onto a connection portion of a bottom portion of the fan unit i.e. the existing ceiling fan assembly 29 by any suitable manner known by those of ordinary skill in the art, though this particular embodiment as illustrated includes a connecter in the form of a ⅜ inch threaded fastener 153 and a retaining nut 155, which is compatible with many ceiling fans currently in use and commerce. The connection of the connecter, that is the fastener 153 and the retaining nut 155, with the connection portion that is adapted to receive the threaded fastener, allows for the easy installation of the ceiling fan accessory unit including the wireless speaker assembly.

Screws 163 may be used to hold the speaker enclosure dome 143, the posts 149, the plate cover 147 and the sound displacement element 159 together, preferably passing through the posts 149, which when assembled comprises the ceiling fan housing member 13. Additional screws ′65 may be used to hold the ceiling fan housing member 13 onto the mounting bracket 145.

A screen 151, when present, may cover the open space 157 between the speaker 17 or speakers 17 and the plate cover 147 and mounting bracket 145. The screen 151 may be made of any suitable material that permits the substantially unaltered transmission of sound from the speaker therethrough. Examples of types of screens include non-solid mesh screens, the mesh potentially substantially comprising fiber or metal or some combination thereof. The screen 151 both provides an aesthetically-pleasing appearance, disguises the presence of the post or posts 149 and other internal components of the present invention, and prevents the introduction of foreign debris onto the speaker 17.

A particularly important aspect of this second embodiment of the present invention is the presence of a sound displacement element 159, which may be in the form of a three-dimensional bell curve, as illustrated in the Figures. The sound displacement element therefore comprises a convex surface, possessing an infinite number of identical potentially bisecting lines through the site of greatest convexity of the sound displacement element. The site of greatest convexity of the sound displacement element is the lowest point of the sound displacement element, when it is horizontally installed, as seen in the Figures. The sound displacement element overcomes problems in the prior art relating to speakers being pointed in the direction of fans, including ceiling fans. Typically, when a speaker is aimed at a fan, the fan blades reflect a portion of the sound waves, while permitting some to pass through, resulting in a distortion of the sound. This problem is overcome through the use of the sound displacement element 159, in part because it prevents the ceiling fan blades 161 from interfering with the sound waves.

As can be seen in the Figures, the sound displacement element 159 should be centralized horizontally within the ceiling fan housing member 13, and directly over the center of the speaker 17. This is critical for proper dispersal of sound from the speaker 17, and to prevent sound interference from the rotating ceiling fan blades 161. The sound displacement element 159 constitutes a significant improvement over the art, and enables the speaker 17 to be pointed upward, which in turn prevents heat from the wiring and other components of the existing ceiling fan assembly 29 from interfering with the speaker 17. The additional electrical components of the ceiling fan housing member 13 of the present invention, such as the receiver 9 and the amplifier 15, may all be housed in the speaker enclosure dome 143 or in the concave cavity of the sound displacement element 159, on the side opposite the speaker 17.

In an embodiment, the speaker 17 or speakers 17 are, upon installation of the ceiling fan housing member 13, oriented so as to direct the greatest amount of sound at the site of greatest convexity of the sound displacement element 159.

In an embodiment, the center of the speaker 17 or speakers 17 is, upon installation of the ceiling fan housing member 13, oriented substantially directly underneath the site of greatest convexity of the sound displacement element 159.

In the present invention, with the presence of the sound displacement element 159, where more than one speaker 17 is present, it is important that those speakers be stacked, so that each may benefit from the presence of the sound displacement element. When so stacked, the center of each speaker 17 should be in line with the center of the sound displacement element 159. The order in which the speakers are stacked may be any.

A plate cover 147, when present, may provide additional structural support to the ceiling fan housing member 13, and may keep debris out of the concave portion of the sound displacement element 159.

This second embodiment, as a part of the speaker enclosure dome 143, may include an illuminating bulb 55 and additional light source components, as detailed elsewhere herein. It is preferred that the lens 37 covering the light source 25 be complimentary in shape to the outer surface of the speaker enclosure dome 143.

In an embodiment, the wireless speaker system 1 is simply installed in an existing ceiling fan 29. As shown in FIG. 2, the existing ceiling fan may contain a light source 25. In another embodiment, the wireless speaker system 1 is installed in a new ceiling fan. Also illustrated in FIG. 2, the wireless speaker system 1 may contain a light source 25 within the ceiling fan housing member 13. In another preferred embodiment, the light source 25 is white LED lighting, which is beneficial due to its negligible heat radiation on the speakers 17. The light source 25 is optionally positioned on the exterior of the speaker enclosure dome 143.

In operation, the audio source generator 3 produces an audio signal that is imputed via the RCA connectors 5 and an audio input cord to the transmitter 7. The audio signal can be produced by a number of various audio source generators 3. In one embodiment, the wireless speaker system 1 is multi-channel, meaning that the audio is selectable from more than one source. The audio source generator 3 can be any audio source provider, not to be limited by the following: television; stereophonic; amplifier; monophonic; video game; home theater; doorbell; security system; intercom; or a public address system.

In an embodiment, channels may be changed remotely, without the need to manually access the ceiling fan housing member 13, which is an improvement over the art. A dip switch, which is a form of spring-loaded click switch that breaks an electrical circuit, and is known by those of ordinary skill in the art, is a preferred component of the present invention, in conjunction with changing channels, in the event interference is encountered in the signal between the transmitter 7 and receiver 9. When present, a dip switch may be located in the transmitter 7, the receiver 9, the remote control 107 or more than one of those. In a preferred embodiment, the dip switch is located in the transmitter 7 and controlled by the remote control 107.

The transmitter 7 (FIG. 1) modulates the audio signal to a radio frequency and then transmits the audio signal wireles sly to a wireless receiver located in the ceiling fan housing member 13 (FIG. 2). The wireless receiver 9 then demodulates the audio signal. Then, as depicted in FIG. 2, the amplifier 15 amplifies the audio sound portion of the audio signal. The amplified sound portion is then sent to the speakers 17. The audio waves then travel through the sound grids 89 (FIG. 3) of each speaker 17 out to the listening audience.

The wireless speaker system 1 is powered by the existing voltage available at the bottom of the ceiling fan also known as the accessory electric power wires or the input power 91 (FIG. 2). A transformer converts the input power 91, 110 VAC, to a lower DC voltage. The DC voltage powers both the receiver 9 and the amplifier 15 {FIG. 2), which in turn powers the speakers 17. In a preferred embodiment, the DC voltage is 12 VDC or 15 VDC. In another embodiment, the DC voltage could be multiple voltages. It should be understood that the aforementioned embodiments are for exemplary purposes only and are merely illustrative of the many possible specific embodiments that can represent applications of the principles of the invention.

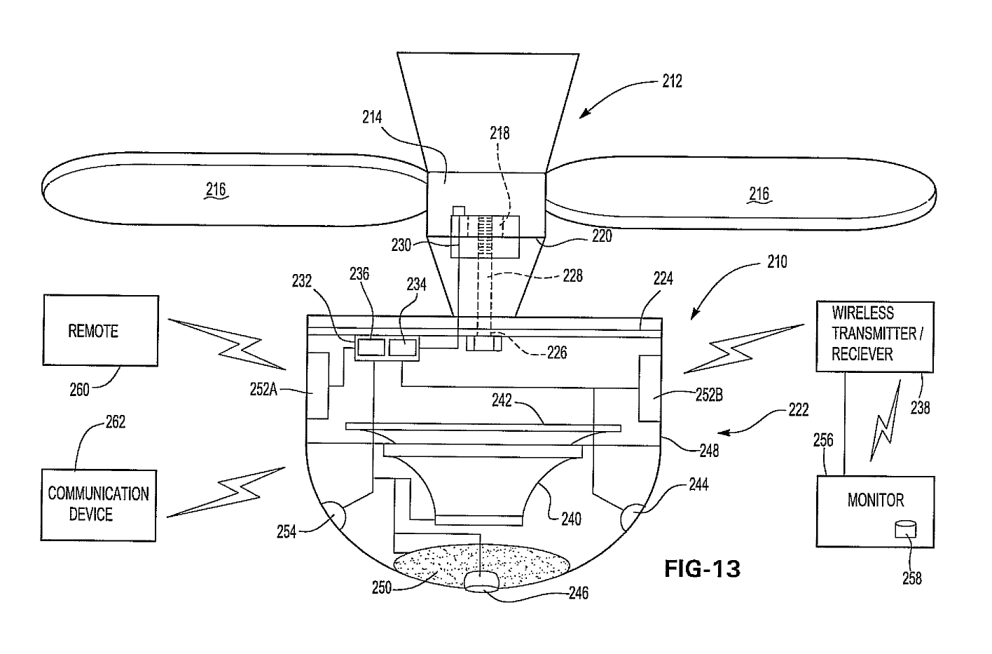

With reference to FIG. 13 a first alternative embodiment of the ceiling fan accessory unit is generally illustrated at 210. The ceiling fan accessory unit 210 attaches to a ceiling fan 212 mounted to a ceiling. The ceiling fan 212 includes a fan unit 214 that houses a fan motor that rotates a plurality of fan blades 216. The fan unit 214 includes a connection portion 218 formed on a bottom portion 220 of the fan unit 214. The connection portion 218 allows for the connection of the ceiling fan accessory unit 210 to the ceiling fan 212.

The housing 222 includes a mounting bracket 224 having an aperture 226 that receives a connector 228. The connection 228 is optionally a threaded fastener, more particularly a 3/8 inch threaded fastener which is used to hangingly support the ceiling fan accessory unit 210 from the ceiling fan 212. The connection portion 218 of the fan unit 214 is adapted to receive the connector 228, and connection portion 218 is optionally formed of an internally threaded shaft to receive the threaded fastener 228.

As FIG. 13 is a schematic illustration of the electrical components contained within the ceiling fan accessory unit 210, it is appreciated of course that the ceiling fan accessory unit 210 includes a similar structure as the previously described embodiment, including a speaker enclosure dome, a plate cover, and a sound displacement element spaced apart from the dome shaped structure by a plurality of posts in which a screen covers the open space between the speaker and the plate cover and the mounting bracket 224. As described above, the screen may be made of any suitable material that permits the substantially unaltered transmission of sound from the speaker therethrough.

The fan unit 214 further includes electrical power wires 230 extending from the bottom portion 218. The electrical power wires 230 and the connection portion 218 allow for the attachment of lighting accessories to existing ceiling fans. The connection portion 218 provides the mechanical connection to the ceiling fan 212 while the electrical power wires 230 provides a power source to the lighting accessory without the need for additional wiring.

The housing 222 includes accessory components that are easily installed to an existing ceiling fan 212 by the attachment of the ceiling fan accessory unit 210 to the connection portion 218 and the electrical power wires 230. The housing 222 includes a controller 232 that is connected to the electrical power wires 230. The controller 232 includes an electric power distributor 234 that operatively connects the various components to the electrical power wires 230 thereby supplying electrical power. The electrical power distributor 234 optionally includes a battery pack and/or a rechargeable power supply which is charged through the electrical power wires 230. In the event of a power outage, the batter pack and/or power supply is operable to supply power to the electrical components contained in the housing 222.

The controller 232 further includes a host wireless transmitter/receiver receiver 236 operable to transmit and receive audio and video signals with a remote wireless transmitter/receiver receiver 238, as described in greater detail below. The controller 232 includes a processor operable to execute programmable logic to operable to control the various electrical components housed in the ceiling fan accessory unit 210.

The housing 222 further includes at least one speaker 240. The speaker 240 is optionally arranged as in the previous embodiment, in which the speaker 240 is oriented upwards towards the fan unit 214 and includes a sound displacement element positioned above the speaker 240. The speaker 240 is connected to the electrical power wires 230 through the electrical power distributor 234.

An amplifier (not shown) is connected to between the controller 232 specifically, the host wireless transmitter/receiver 236 and the speaker 240. In addition, the ceiling fan accessory unit 210 includes a sound displacement element 242 positioned above the speaker 240 to radially displace the audible output, when the speaker 240 is positioned to direct the audible output towards the ceiling fan 212. In a configuration in which the speaker 240 is positioned to direct the audible output in a direction opposite the direction towards the ceiling fan, that is when the speaker 240 is facing downwards, a sound displacement element is optional but not required.

In order to provide a monitoring function to the ceiling fan accessory unit 210, the housing 222 includes at least one microphone 244 and/or at least one imaging device 246. The microphone 244 is mounted to the housing 22 so as to be able to detect audible sounds from the ceiling fan environment. Optionally, the microphone 242 is positioned to be mounted on an exterior of the housing 222 or extending though openings formed in the housing 222. The microphone 242 is connected to the controller 232 to transmit audible signals to the remote wireless transmitter/receiver 238 through the host wireless transmitter/receiver 236. Further, the microphone 242 is connected to the electric power wires 230 through the electric power distributor 234.

The imaging device 246 is a device operable to take video/picture images of the ceiling fan environment. The imaging device 246 is optionally a camera and/or video recorder, such as a fish eye camera, that captures visual signals including video, time elapsed, and/or still images of the ceiling fan environment. The imagining device 246 optionally includes difference operating functions illustratively night vision mode and infrared mode The imaging device 246 is optionally positioned centrally at the lower portion of a domed shaped portion 248, as described above, of the housing 222. Specifically, the imaging device 246 is positioned in a lens covering a light source 250. In the alternative, the ceiling fan accessory unit 210 is provided with a plurality of imagining devices 246 so as to provide a wide area of visual detection include 360° of visual detection around the ceiling fan accessory unit 246.

The light source 250 is optionally in the form of a light bulb or a plurality of Light Emitting Diodes (LEDs). The light source 250 is connected to the electrical power wires 230 through the electric power distributor 234.

The ceiling fan accessory unit 210 further includes at least one security device 252 that is mounted to the housing 222. The security device 252 is connected to the speaker 240 through the controller 232 and the electric power wires 230 through the electric power distributor 234. The security device 252 detects for the occurrence of a predetermined condition and upon the detection of the occurrence of the predetermined condition the security device 252 outputs a signal to control the at least one speaker 240 to issue an audible output, such as an alarm. The audible output is optionally a preprogrammed sound or a programmable speech output.

The security device 252 includes various types of sensors or detectors that detect for the occurrence of a predetermined condition. Illustratively including, the security device 252 is optionally a glass break detector, a smoke detector, a carbon monoxide detector, a motion detector, a heat detector, a RFID tag reader, and a retina reader. By providing the ceiling fan accessory unit 210 with at least one security device 252 allows for the easy installation of a required detector, such as residential or industrial commercially available smoke detector or carbon monoxide detector to an existing power wire (i.e. the electric power wires 230) without the need for the installation of new wiring.

The security device 252 is optionally a glass break sensor that detects if glass is shattered or broken. Glass break sensors are commercially available and utilize a microphone 244 to monitor any noises or vibrations coming from glass such as a window. The glass break sensor includes circuitry that analyzes detected noise and vibration to determined the breakage if the noise/vibrations exceed the predetermined threshold and controls the speaker to issue an audible output. Alternatively, the glass break sensor is paired with a narrowband microphone that is tuned to a frequency of typical glass shattering. The determination that the glass break sensor has deterred that glass has shattered is the predetermined condition, and the security device 252 will control the speaker 240 to issue an audible output.

Similarly, the smoke detectors and carbon monoxide detectors are known in the art to detect a condition that relates to the presence of smoke or a level of carbon monoxide above an acceptable threshold. The security device 252 in the form of a smoke detector or a carbon monoxide detector includes the predetermined condition that would trigger the smoke or carbon monoxide detectors as the predetermined condition and would control the speaker to issue an audible output to warn of the presence of smoke or the elevated level of carbon monoxide.

The security device 252 is optionally a motion sensor that detects physical movement in a detection area. The motion sensor is optionally any one of various commercially available motion detectors and uses as the predetermined condition the detection of movement above a predetermined threshold. The predetermined threshold allows for the motion detector to be activated while pets are located within the detection area without triggering the motion detection and therefore the security device 252 which controls the speaker 240 to issue an audible output.

The security device 252 is connected to the controller 232 including the host wireless transmitter/receiver receiver 236 which is in communication with the remote wireless transmitter/receiver receiver 238. The remote wireless transmitter/receiver receiver 238 is optionally connected through a wired, wireless, or network connection to a monitor 256. The monitor 256 is optionally a security system that monitors the detection of the predetermined condition from the security device 252. The connection between the monitor 256 and the ceiling fan accessory unit 210 allows for the monitor 256 to transmit a signal to the controller 232 to issue an audible output from the speaker 240 upon the triggering of a detector or alarm connected to the monitor 256 and remote from the ceiling fan accessory unit 210. As such, the monitor 256 can provide an audible alarm to warn occupant about a security or emergency issue that is remote from the ceiling fan accessory unit 210.

The monitor 256 is itself either a stand alone system or a system in communication with a satellite monitoring facility that receives the output of the security device 252 and will direct emergency services the location of the ceiling fan accessory unit 210. Specifically, the monitor 256 or the satellite facility will fire, police, ambulance upon the triggering of the smoke detector, the motion detector, and the carbon monoxide detector.

The security device 252 is optionally connected to the monitor 256 and the satellite facility through a wired connection. The monitor 258 optionally includes a storage device 258 that is capable of storing audio signals detected by the microphone 244 and visual signals including videos and still images from the imaging device 246. The storage device 258 is optionally a steady state storage medium, a volatile memory medium, or includes writable storage device such as a CD/DVD writer that stores the recorded audio and visual signals to a CD/DVD. The satellite facility being capable of monitoring the audio and visual signals from the microphone 244 and imaging device 246 remotely.

In addition, ceiling fan accessory unit 210 further includes an electric animal and/or pest repellant 254. The pest repellant 254 is optionally a part of the security device 252 or a separate component. The pest repellant 254 is connected to the electric power wires 230 through the electric power distributor 234 and to the speaker 240 through the controller 232. Upon the determination of an occurrence of a predetermined condition, such as a timer or the activation of an on condition, the pest repellant 254 controls the speaker 240 to issue an audible output having a wavelength and a frequency to deter the presence of animals and/or pests. The pest repellant 254 is optionally an ultrasonic device that emits short wavelength, high frequency sound waves that are above the hearing frequency of human ears, to repel the presence of animals and/or pests.

The ceiling fan accessory unit 210 is in communication with the remote wireless transmitter/ receiver 238 to send and receive audio and visual signals. Specifically, the remote wireless transmitter/ receiver 238 is connected to an audio source generator illustratively including a television, radio, media player, intercom, doorbell, that generates an audio signal to be transmitted from the remote wireless transmitter/ receiver 238 to the host wireless transmitter/receiver 236. The speaker 240 which is in communication with the host wireless transmitter/receiver 236 is operable to output the received audio signal.

The ceiling fan accessory unit 210 is operable to communicate with additional devices such as a remote control 260, as described above, that controls the volume, channel, and power of the speaker 240, the light source 250, the security devices 252 so as to test or deactivate an activated smoke detector, carbon monoxide detector, motion detector, and/or pet repellant 254. The remote control 260 is optionally an executable application run on a smart device illustratively including a portable cellular telephone, a portable computer, a tablet device, or a computer. The application is in communication with the wireless transmitter/receiver 236 to control the operation of the speakers 240 and any of the electronic components of the ceiling fan accessory unit 210, including the security device 252 and the imaging device 246.

Further still, the ceiling fan accessory unit 210 is operable to communication with a communication device 262 to transmit and receive both audio and visual signals. The communication device 262 optionally includes a portable cellular telephone, laptop, smart device, tablet computer, or desktop computer. The communication between the communication device 262 and the ceiling fan accessory unit 210 allows for the ceiling fan accessory unit 210 to act as a two way communicator such that audio signals are transmitted between the communication device 262 and the ceiling fan accessory unit 210 through the use of the microphone 244 and the speaker 240. Moreover, the imaging device 246 allows for the visual communication between the ceiling fan accessory unit 210 and the communication device 262 that has a display device. The display device of the communication device 262 displays the visual images detected by the imaging device 246. The communication device 262 allows for the ceiling fan accessory unit 210 to act as an audio and visual monitor for various application, including security camera (i.e. monitoring a residence or commercial area), a baby monitor, or other various function without the need to install additional equipment and provide for additional wiring.

The ceiling fan accessory unit 210 is operable to communicate through the host wireless transmitter/receiver 236 through various communication standards including, a wireless radio frequencies, wireless internet connection, infrared, Bluetooth® standard protocols, cellular telephone networks, or any other wireless communication network known to those of ordinary skill in the art. The controller 232 connects the various electrical components to the speaker 240 and allows the control of the speaker 240 by the various electrical components, including the microphone 244, the imaging device 246, the security devices 252, the pest repellant 254, the remote control 260, the communication device 262, the remote wireless transmitter/receiver 238, and the monitor 256.

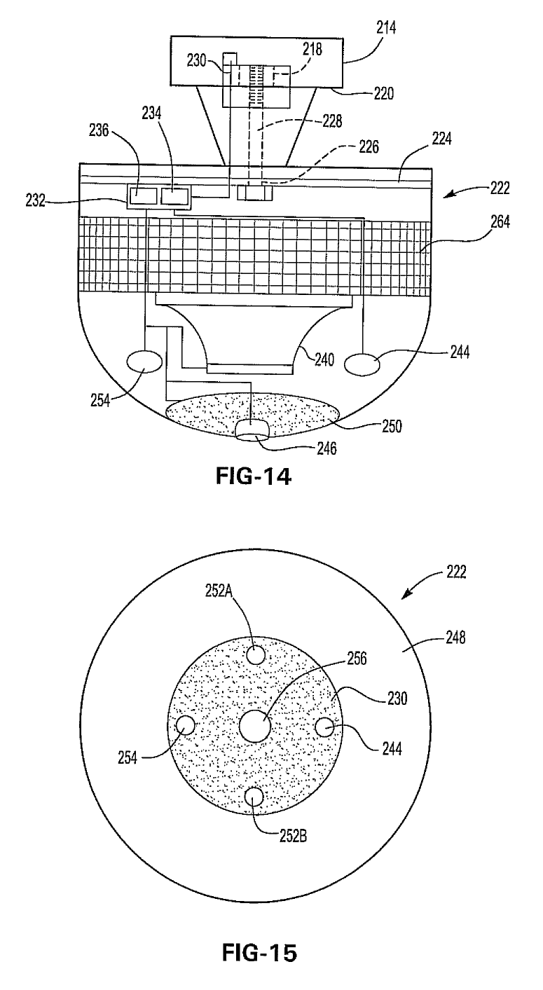

With reference to FIGS. 14 and 15 a modified alternative embodiment of the ceiling fan accessory unit 210 is illustrated. In the modified embodiment, the housing 222 includes a screen 264 between the dome shaped portion and the mounting bracket 224. In addition, openings are formed in the lens cover of the light source 250, as best seen in FIG. 15. The opens are formed to house the various electrical components of the ceiling fan accessory unit 210. Specifically, the imaging device 250, the microphone 244, the security devices 252A and 252B, and the pest repellant 254 are provided on the lower portion of the housing 222 for improved performance. By providing the microphone 244 on the lower portion, the noise from the fan unit 214 is lessened. Further, security devices 252, such as the smoke detector and the carbon monoxide detector are shielded from wind caused by the rotation of the fan blades 216. Moreover, the imaging device 246 and the security device 252 have a clear view of the detection area below the existing ceiling fan 212. In the alternative, the security devices 252A and 252B are replaced with additional imaging devices to provide an increase in the detection area of the visually viewable area of the imaging devices.

Without departing from the spirit and scope of this invention, one of ordinary skill in the art can make various changes and modifications to the invention to adapt it to various usages and conditions, including those not specifically laid out herein. As such, those changes and modifications are properly, equitable, and intended to be, within the full range of equivalents of the invention disclosed and described herein.

It is claimed:

1. A ceiling fan accessory unit that mounts to a ceiling fan having a fan unit that houses a fan motor that rotates a plurality of fan blades, the fan unit having a bottom portion having electric power wires and a connection portion adapted to receive a connector, said accessory unit communicates with a wireless transmitter that transmits audio signals, said ceiling fan accessory unit comprising:
a housing adapted to be mounted to the connection portion of the bottom portion of the fan unit to hangingly support said housing from the fan unit of the ceiling fan;
a wireless receiver mounted to said housing, said wireless receiver adapted for connection to the electrical power wires of the fan unit, said wireless receiver communicates with the wireless transmitter to receive the audio signals; and
at least one speaker mounted to said housing, said at least one speaker adapted for connection to the electrical power wires of the fan unit and said at least one speaker in communication with said wireless receiver to output the audio signals transmitted from the wireless transmitter.

2. The ceiling fan accessory unit of claim 1, wherein said ceiling fan accessory unit includes a threaded fastener as said connector, wherein the connection portion is adapted to receive said threaded fastener to mount said housing to the fan unit of the ceiling fan.

3. The ceiling fan accessory unit of claim 2 further comprising a light source mounted to said housing, said light source adapted for connection to the electrical power wires.

4. The ceiling fan accessory unit of claim 2, wherein said housing includes a mounting bracket, said mounting bracket having an aperture, and wherein said connector extends through said aperture to mount said housing to the connection portion of the fan unit of the ceiling fan.

5. The ceiling fan accessory unit of claim 4 further comprising an amplifier mounted to said housing, said amplifier connected between said wireless receiver and said at least one speaker.

6. The ceiling fan accessory unit of claim 5, wherein includes a domed shaped portion at a lower end of said housing, and said at least one speaker disposed within said domed shaped portion and wherein said housing includes a sound displacement element positioned between said mounting bracket and said at least one speaker, said sound displacement element having an annular portion and a convex central portion extending towards said at least one speaker, said convex central portion position over a center of said at least one speaker, said annular portion is spaced apart from an upper end of said domed shaped portion.

7. The ceiling fan accessory unit of claim 6, wherein said sound displacement element directs the audio signal output from said at least one speaker in a radially direction through said space between said annular portion and said upper end of said dome shaped portion.

8. The ceiling fan accessory unit of claim 7, wherein a plurality of posts extend between said annular portion and said upper end of said domed shaped portion.

9. The ceiling fan accessory unit of claim 8, wherein a sound permeable material covers said space between said annular portion of said sound displacement element and said upper end of said domed shaped portion.

10. The ceiling fan accessory unit of claim 1, wherein the wireless transmitter is connected to a remote audio source generator selected from the group consisting of a television, a stereo, an amplifier, a video game, a home theater system, a public address system, an intercom system, a doorbell, and a security system.

11. The ceiling fan accessory unit of claim 1 further comprising a microphone mounted to said housing, and wherein said wireless receiver is capable of sending and receiving audio signals to and from the wireless transmitter, and wherein the wireless transmitter is a communication device that allows for two way audio communication between said ceiling fan accessory unit and the communication device.

12. The ceiling fan accessory unit of claim 11 further comprising an imaging device mounted to said housing, and wherein said wireless receiver is capable of sending image signals to the wireless transmitter, and wherein the wireless transmitter is a communication device that allows for visual communication between said ceiling fan accessory unit and the communication device.

13. The ceiling fan accessory unit of claim 12, wherein the wireless receiver is connected to a storage device remote from said ceiling fan accessory unit, and wherein audio output from said microphone and visual output from said imaging device is stored on said remote storage device.

14. A ceiling fan accessory unit that mounts to a ceiling fan having a fan unit that houses a fan motor that rotates a plurality of fan blades, the fan unit having a bottom portion having electrical power wires and a connection portion adapted to receive a connector, said ceiling fan accessory unit comprising:
a housing adapted to be mounted to the connection portion on the bottom portion of the fan unit to hangingly support the housing from the fan unit of the ceiling fan;
at least one speaker mounted to said housing, said at least one speaker adapted for connection to the electric power wires; and
a security device mounted to said housing, said security device adapted for connection to the electric power wires and said at least one speaker, said security device detects for the occurrence of a predetermined condition and upon said security device detecting said occurrence of said predetermined condition outputs a signal to control said at least one speaker to issue an audible output.

15. The ceiling fan accessory unit of claim 14, wherein said security device is selected from the group consisting of a glass break detector, a smoke detector, a carbon monoxide detector, and a motion detector.

16. The ceiling fan accessory unit of claim 14, wherein said security device is an electric animal and/or pest repellant that controls said at least one speaker to issue an audible output having a wavelength and a frequency to deter the presence of animals and/or pests.

17. The ceiling fan accessory unit of claim 15, wherein said security device is in communication with a security system, said security system monitors said security device for the output of said signal determining that said predetermined condition has occurred, said security system operable to issue a security signal to control said at least one speaker to issue an audible output.

18. The ceiling fan accessory unit of claim 14, wherein said ceiling fan accessory unit includes a threaded fastener as said connector, wherein the connection portion is adapted to receive said threaded fastener to mount said housing to the fan unit of the ceiling fan.

19. A ceiling fan accessory unit that mounts to a ceiling fan having a fan unit that houses a fan motor that rotates a plurality of fan blades, the fan unit having a bottom portion having electrical power wires and a connection portion adapted to receive a threaded fastener, said accessory unit communicates with a wireless transmitter that transmits audio signals, said ceiling fan accessory unit comprising:
a housing adapted to be mounted by a threaded fastener to the connection portion of the bottom portion of the fan unit to hangingly support said housing from the fan unit of the ceiling fan;
a wireless receiver mounted to said housing, said wireless receiver adapted for connection to the electrical power wires of the fan unit, said wireless receiver communicates with the wireless transmitter to send and receive audio signals;
at least one speaker mounted to said housing, said at least one speaker adapted for connection to the electrical power wires of the fan unit, said at least one speaker in communication with said wireless receiver to output the audio signals transmitted from the wireless transmitter;
a microphone mounted to said housing and adapted for connection to the electric power wires, said microphone in communication with said wireless receiver to transmit audio signals to the wireless transmitter;
an imaging device mounted to said housing, said imaging device adapted for connection to the electric power wires, said imaging device in communication with said wireless receiver to transmit visual signals to the wireless transmitter; and
a security device mounted to said housing, said security device adapted for connection to the electric power wires and said at least one speaker, said security device detects for the occurrence of a predetermined condition and upon said security device detecting said occurrence of said predetermined condition outputs a signal to control said at least one speaker to issue an audible output.

20. The ceiling fan accessory unit of claim 19, wherein said security device is selected from the group consisting of a glass break sensor, a smoke detector, a carbon monoxide detector, and a motion detector.
